(19) United States
(12) Patent Application Publication
(10) Pub. No.: US 2015/0186539 A1
(43) Pub. Date: Jul. 2, 2015

(54) SYSTEM AND METHODS THEREOF FOR GENERATION OF WIDGETS BASED ON ENTITIES

(71) Applicant: Doat Media Ltd., Tel Aviv (IL)

(72) Inventors: Joey Joseph Simhon, Ramat-Gan (IL); Amir Taichman, Haifa (IL); Avi Charkam, Givataim (IL); Dvir Volk, Tel Aviv (IL)

(73) Assignee: Doat Media Ltd., Tel Aviv (IL)

(21) Appl. No.: 14/580,684

(22) Filed: Dec. 23, 2014

Related U.S. Application Data
(60) Provisional application No. 61/920,783, filed on Dec. 26, 2013.

(51) Int. Cl. G06F 17/30

(52) U.S. Cl. CPC G06F 17/30867

(57) ABSTRACT

A method and system for generating an entity based widget are provided. The method includes receiving a request to generate at least one entity based widget; searching for content related to the at least one entity; determining at least one entity based on the content items found during the search; generating at least one entity-based widget respective of the contextual content and the entity; and providing the at least one entity-based widget to a user device.

### CROSS REFERENCE TO RELATED APPLICATIONS

This application claims the benefit of U.S. provisional application No. 61/920,783 filed on Dec. 26, 2013, the contents of which are herein incorporated by reference.

### TECHNICAL FIELD

The disclosure generally relates to methods for searching for content through the web, and more specifically to methods for generating widgets respective of the content.

### BACKGROUND

Webpages are information resources suitable for the World Wide Web (WWW) and which can be accessed through a web browser. Webpages typically contain content such as video content, images, RSS feeds, chats, and the like, that is intended for display and/or interaction on a user's display device.

The use of mobile devices, such as smart phones, mobile phones, tablet computers, and other similar devices, has significantly increased in past years. Such mobile devices allow access to a variety of application programs also known as “applications” or “apps.” The applications are usually designed to help a user of a mobile device to perform a specific task. Applications may be bundled with the computer and its system software, or may be accessible, and sometimes downloadable, from a central repository such as, for example, the App Store™ by Apple®.

Through such applications' repositories, users can download applications for virtually limitless purposes, limited only by the amount of memory available on the users' phones. Applications exist for social media, finance, news, entertainment, gaming, and more. Some applications serve multiple purposes and/or offer multiple types of content.

The interaction of users with content displayed in webpages or otherwise in mobile applications is usually limited by the functionality sets by the mobile applications or websites. For example, in order to respond to a chat message received on Facebook® chat, a user of a user device has to access the Facebook® website or application. This limitation inhibits a user's ability to fully interact with content on the WWW.

Currently the related art does not disclose any solution for providing an interactive element by which users can customize the display and/or interaction with content existing over the web independent of webpage requirements and limitations.

It would therefore be advantageous to provide a solution that would overcome the deficiencies of the prior art.

### SUMMARY

A summary of several example aspects of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor delineate the scope of any or all aspects. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Certain embodiments include a method for generating an entity based widget. The method comprises receiving a request to generate at least one entity based widget; searching for content related to the at least one entity; determining at least one entity based on the content items found during the search; generating at least one entity-based widget respective of the contextual content and the entity; and providing the at least one entity-based widget to a user device.

Certain embodiments include a system for generating an entity based widget. The system comprises: a processing unit; and a memory connected to the processing unit, the memory containing instructions that when executed by the processing unit, configure the system to: receive a request to generate at least one entity based widget; search for content related to the at least one entity; determine at least one entity based on the content items found during the search; generate at least one entity-based widget respective of the contextual content and the entity; and provide the at least one entity-based widget to a user device.

### BRIEF DESCRIPTION OF THE DRAWINGS

The subject matter disclosed herein is particularly pointed out and distinctly claimed in the claims at the conclusion of the specification. The foregoing and other objects, features and advantages of the disclosed embodiments will be apparent from the following detailed description taken in conjunction with the accompanying drawings.

FIG. 1 is a schematic diagram of a network system utilized to describe the various disclosed embodiments;

FIG. 2 is a schematic diagram of an agent for generation of entity based widgets utilized to describe the various disclosed embodiments;

FIG. 3 is a flowchart describing the operation of a method for generation of entity based widgets according to an embodiment; and

FIG. 4 is a flowchart describing the operation of a process for determining if an entity matches textual content.

### DETAILED DESCRIPTION

The disclosed embodiments are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

By a way of example, certain embodiments disclosed herein include a system and method for generating widgets based on the certain entities. An entity for a widget may be determined based on contextual search results and/or an input query. An entity is a topic of interest describing an object in the world that can be defined with known types and attributes. Entities may be, for example, products, people, locations, companies, music bands, popular keywords, applications, zip codes, and query components. Respective of the determined entity an entity-based widget is generated and then displayed on the user device.

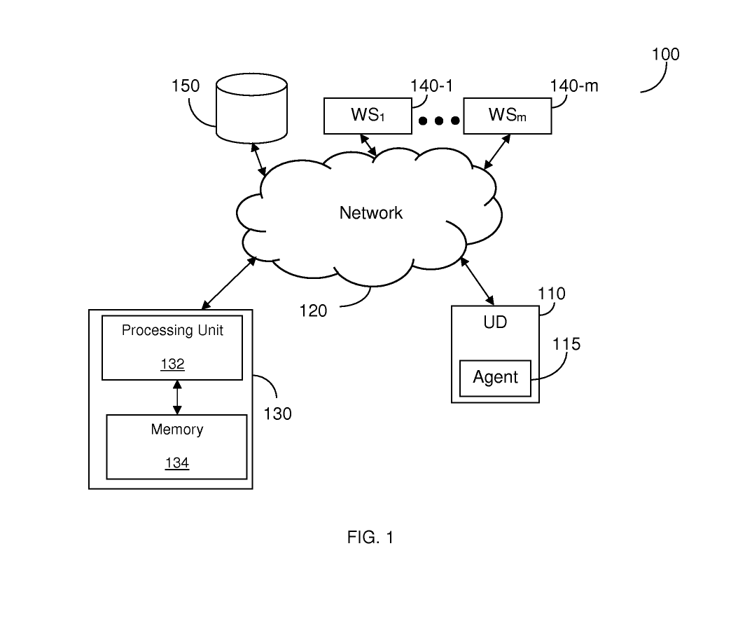

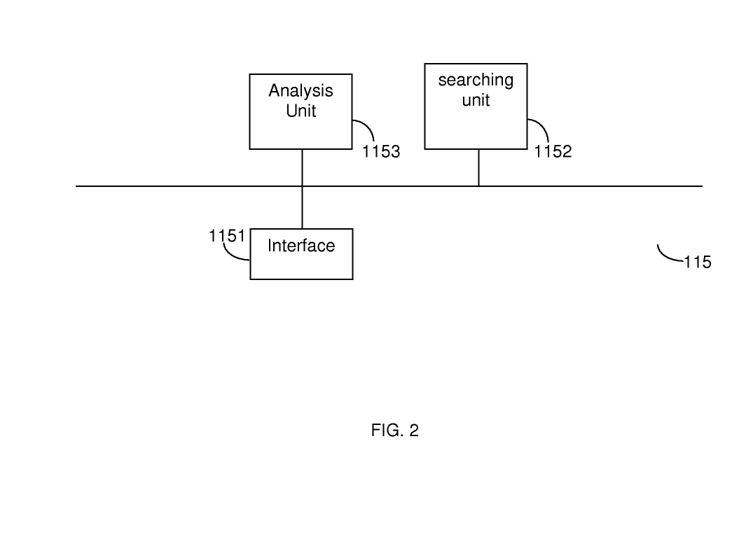

FIG. 1 depicts an exemplary and non-limiting schematic diagram of a network system 100 utilized to describe the various disclosed embodiments. A user device 110 is connected to a network 120. The user device 110 may be a smartphone, a mobile phone, a laptop computer, a tablet computer, a wearable computing device, a personal computer (PC), a smart television (TV), and the like. The user device is installed with an agent 115 for interacting with the user. The agent 115 may be a dedicated application, script, or any program code stored in the memory (not shown) of the user device 110 and is executable, for example, by the operating system of the user device 110. An exemplary implementation of the agent 115 is described in further detail herein below with respect to FIG. 2.

The network 120 may be a local area network (LAN), a wide area network (WAN), a metro area network (MAN), the Internet, the worldwide web (WWW), a wireless network, a wired network, a cellular network, the like, and any combinations thereof.

In accordance with one embodiment, a server 130, which is also connected to the network 120, is configured to generate entity-based widgets using content accessible through the network 120. Specifically, the content may be gathered from one or more web sources 140-1 through 140-M (collectively referred to hereinafter as web sources 140 or individually as a web source 140). The web sources 140 include, for example, web search engines, vertical comparison engines, servers of content providers, and servers of content publishers, data warehouses, and the like. According to another embodiment, the entity-based widgets may be generated based on the content locally stored on the user device 110.

The server 130 is configured to receive a request to generate an entity-based widget from the user device 110. The request may include a query in a form of a keyword or a user gesture over certain content of interest to the user. The selection may also include an explicit selection of the entity. A user's gesture may be, for example, a scroll or a tap on a certain area of the display of the user device 110.

In another embodiment, together with the request, the server 130 further receives from the user device 110 a selection of one or more web sources of the web sources 140 to collect content therefrom. As an example, a query received from a user device 110 including the keyword “Madonna” as the entity and “Twitter®” as the web source to collect contextual content related to Madonna therefrom.

According to various disclosed embodiments, the server 130 is then configured to search for content related to the request. The search may be for the content this related to the keyword, gesture, or entity designated in the request. In an embodiment, the server 130 is configured to search for content that is contextually related to the keyword, gesture, or entity.

Based on the collected contextual content, the server 130 is configured to determine the entity. For the determination, the server 130 may be preconfigured with a set of rules stored in a database 150. A rule may be, for instance, a determination that an entity is an artist upon identification of a number of mentions of the entity's name and the word “art” above a certain threshold... For example, Michael Jackson may be classified as a musician, Microsoft® as a company, etc.

According to another embodiment, the entity is determined using a set of classification engines that may be included or otherwise operated by the server 130. The classification engines are discussed in more detail below. According to yet another embodiment, the entity may be received from the user device together with the selection of the entity. Respective of the entity and the contextual content collected, the server 130 is configured to generate a widget.

A widget is a stand-alone application with limited functionality that can be installed and executed on the user device 110 or within a webpage accessed by the user device 110. The widget may be overlaid over an already existing content item. The widgets may comprise links (e.g., hyperlinks) to content existing over the network 120 related to the entities.

According to one embodiment, a generated widget is configured to communicate through the network 120 with the respective web sources 140. The communication allows the widgets to be updated with changes to content items when a network connection is available.

It should be emphasized that different widgets may be generated respective of different types of entities. As an example, a widget generated for the artist Justin Bieber may contain his clips or links thereto, information about upcoming concerts, and the like, while a widget generated for Apple® computers may include links to news about Apple® devices, frequently asked questions and answers, ways to contact Apple® computers' costumer services, and the like.

The widget generated by the server 130 can be created, installed, and executed on the user device 110. In an embodiment, the installed widget may communicate with the agent 115 when the user device 110 is offline to be updated with changes created by the user. In another embodiment, the widget is executed by the server 130 relevant content is rendered and sent to display over the user device 110.

According to another embodiment, a link to the widget is sent to the user device 110. The link may be represented by an icon generated by the server 130. In a non-limiting example, a user enters a query for “Yankees®” as the entity and “ESPN®” as the web source in the agent 115. Then, a widget displays over the display of the user device 110, containing more information pertaining to the Yankees® on ESPN.com®, such as other player rosters, recent player acquisitions, draft picks, game scores, and the like. In another embodiment, an icon is generated by the server 130 to link to the widget and is sent to the user device 110 as a text message, email, or other communicative means.

The server 130 typically includes a processing unit 132 and memory 134 containing instructions to be executed by the processing unit 132. The processing unit 132 may comprise, or be a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing unit 132 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing unit, cause the processing unit to perform the various functions described herein.

FIG. 2 depicts an exemplary and non-limiting schematic diagram of the agent 115 installed on the user device 110. The agent 115 comprises an interface 1151 through which the agent 115 receive a selection of at least one entity from the user of the user device 110. The selection of the entity may be received as a query or as a gesture over certain content related to the selected entity. A user's gesture may be, for example, a scroll or a tap on a certain area of the agent 115 displayed on the interface 1151. Respective of the selection, a searching unit 1152 (SU) is configured to search for contextual content related to the selected entity. The selection may be performed locally through the content stored in the user device 110 and/or via the network 120 through one or more web sources 140. It should be noted that the local search does not require a connection to the network 120. In an embodiment, the user will indicate via the interface 1151 which web sources 140 to search for content.

The agent 115 further comprises an analysis unit 1153 configured to determine the entity based on the collected contextual content. For the determination, the analysis unit 1153 may be preconfigured with a set of rules based on a set of predefined rules. A rule may be, for instance, a determination that an entity is an artist upon identification of a number of mentions of the entity's name and the word “art” above a certain threshold. In an embodiment, the analysis unit 1153 is configured to query the server 130 for a determination of entity. Based on the determined entity and the contextual content collected, the analysis unit 1153 is configured to generate a widget as further described hereinabove with respect of FIG. 1. The various units of the agent 115 can be implemented in hardware, software, firmware or any combination thereof.

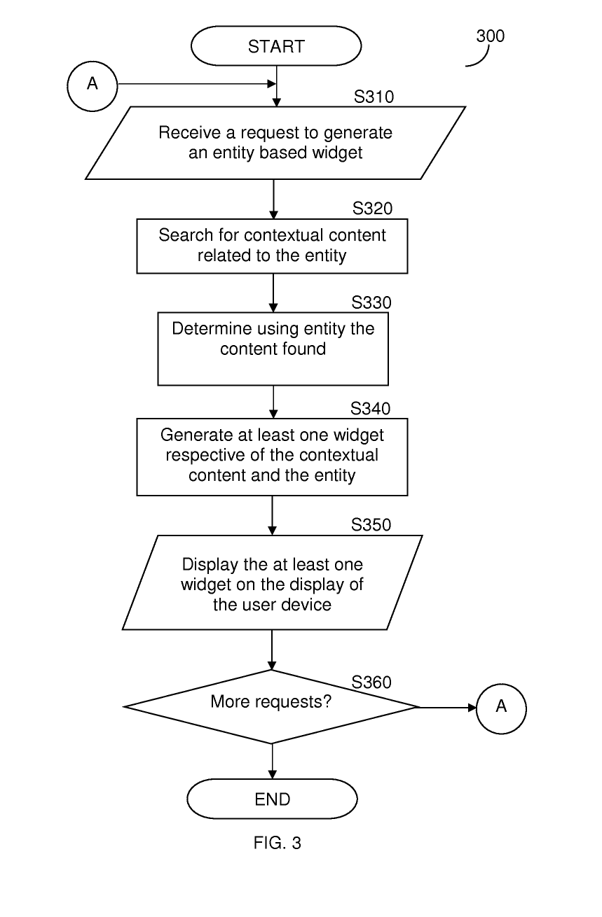

FIG. 3 depicts an exemplary and non-limiting flowchart 300 of a method for generation of entity-based widgets according to an embodiment. In S310, a request to generate an entity based widget is received. This request may be initiated upon a query provided by the user of a user device. Such a query may be an explicit keyword or a gesture detected with respect to content displayed on the user device as further described hereinabove with respect to FIG. 1.

In S320, a search for content related to the entity is performed through the web sources (e.g., web sources 140). In an embodiment, the S320 may further include a local search through the user device 110 for content stored therein. According to one embodiment, a selection of which web sources 140 to search for content may be received as an input from the user device 110 as further described hereinabove. Content may be considered related according to its context, location, pre-defined criteria, and the like. The content detected through the search may be textual, multimedia content, and the like.

In S330, an entity is determined based on the contextual content found during the search. According to the disclosed embodiments, an entity is a topic of interest. An entity is an “object” in the world that can be defined with known types and attributes. Entities may be, for example, products, people, locations, companies, music bands, popular keywords, applications, zip codes, and query components.

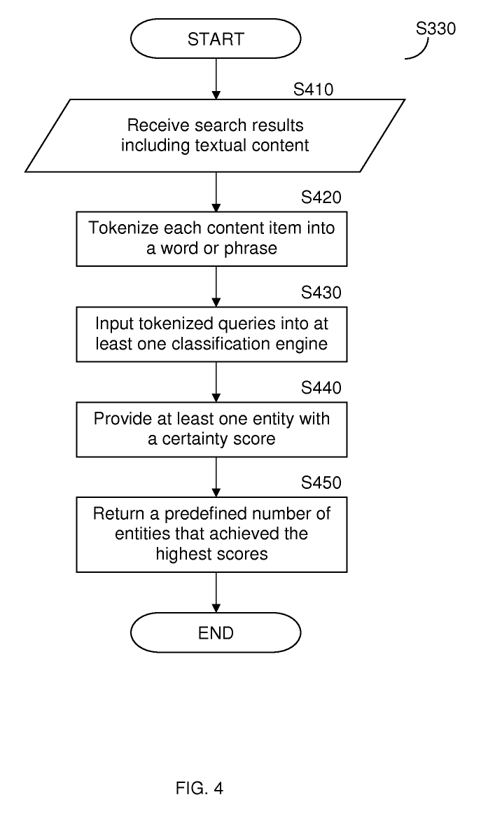

To this end, the content is analyzed and matched against different entities' categories. The entity is based on content that best matches one of the entities categories. In an embodiment, each entity can be associated with one or more classification engines describing its essence. For example, an entity ‘Madonna’ can be associated with the classifications singer, actor, and celebrity. A non-limiting implementation for S330 is provided in FIG. 4.

Alternatively or collectively, S330 may further include an analysis of the query received from the user device 110. In an embodiment, the analysis of the query is performed to determine the user search intent. The user's search intent (hereinafter user intent) represents the type of actions the user wishes to allow other users to perform on the content for a certain period of time. For example, the user intent may represent the user's desire to view, download, and/or listen to a clip. An exemplary process and system for detecting the user search intent can be found in co-pending U.S. patent application Ser. No. 14/103,536, assigned to common assignee, which is hereby incorporated by reference for all that it contains.

As a non-limiting example for the operation of S330, the query “Microsoft Inc.” is received from the user device 110. Based on the mention of the term “Inc.” the entity is classified as a company. Furthermore, as content related to the term “Microsoft Inc.” appeared in The NASDAQ Stock Market, the company is determined as publically trade in NASDAQ. Therefore the entity is further classified as a publically traded company. In an embodiment, the entity is directly provided by the user.

In S340, at least one widget is generated based on the determined entity. The generated widget is a stand-alone application with limited functionality which may comprise links to content related to the determined entity. The widget is configured to connect to the web sources or the user device (e.g., through the agent) and retrieve information related to the determined entity. Any new content published, posted, etc. by a web source determined to be relevant is automatically retrieved or otherwise pushed to the widget.

It should be noted that different types of widgets may be generated depending on the determined entities. The type of the widget may be extracted from the database 150.

For example, based on the classification from the query “Microsoft Inc.” that the entity is a company and the determination that the company is traded on NASDAQ, a widget is generated comprising links to Microsoft's NASDAQ profile from, for example, Yahoo® finance. However, if the query was “Microsoft Computers” a company not traded on the stock exchange, a widget may be generated comprising links to tech news related to Microsoft's products.

In S350, the generated widget is instantiated on the display of the user device 110. In one embodiment, the widget is created, installed, and/or executed on the user device 110. In another embodiment, the widget is created within a webpage accessed by the user device 110. In S360, it is checked whether there are additional requests and if so, execution continues with S310; otherwise, execution terminates.

It should be noted that the method described in FIG. 3 can be performed by the server 130 (see FIG. 1) or the user device 110 by means of the agent 115 (see FIG. 1).

FIG. 4 depicts an exemplary and non-limiting flowchart S330 of a process for determining if an entity matches textual content. In S410, related content found during the search is received. In S420, textual information associated with the received content items is tokenized into tokens which may be a word or phrase. Such textual information may include, for example, metadata associated with the received content, a URL of the content, web pages, and so on.

In S430, the tokens are input into at least one classification engines. In an embodiment, each engine computes the probability that a token is mapped to at least an entity that the engine is configured with. As noted above, an entity represents a topic of interest. The probability computation is realized by a certainty score.

The classification engines are configured to handle one or more different topics of interest. In one embodiment, the classification engines are configured to map input tokens to entities. As noted above, entities are objects that can be defined using a set of attributes such as consumer goods, locations, keywords, mobile applications (apps), person names, questions, URLs, and so on. The engines are periodically updated with relevant content and are therefore consistent with the trends related to the respective topics.

According to one embodiment, the probability may be computed based on at least one of: the frequency of appearance of the tokens within entities maintained by the engines, the correlation of the tokens to the entities, the matching between each of the tokens to the entities, and so on. As noted above, entities represent topics of interests.

In S440, at least one entity is provided together with a certainty score by each of the classification engines. As an example, the tokenized query ‘Madonna’ can be mapped to the entities: ‘musician’ and ‘religious figure’. As noted above, in an embodiment, entities with certainty scores below a predefined threshold are not output by the engines. In S450, a predefined number of entities that achieved the highest scores are returned.

The various embodiments may be implemented as hardware, firmware, software, or any combination thereof. Moreover, the software is preferably implemented as an application program tangibly embodied on a program storage unit or tangible computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. All or some of the servers maybe combined into one or more integrated servers. Furthermore, a non-transitory computer readable medium is any computer readable medium except for a transitory propagating signal.

The various components and functions represented described herein, may be implemented using any suitable means. Such means are implemented, at least in part, using corresponding structure as taught herein. For example, the components described above in conjunction with the system and/or financing server may correspond to components using similarly designated “means for” functionality. Thus, one or more of such means may be implemented using one or more components, integrated circuits, or other suitable structure as taught herein in some implementations.

All examples and conditional language recited herein are intended for pedagogical purposes to aid the reader in understanding the principles and the concepts contributed by the inventor to furthering the art, and are to be construed as being without limitation to such specifically recited examples and conditions. Moreover, all statements herein reciting principles, aspects, and embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for generating an entity based widget, comprising:
receiving a request to generate at least one entity based widget;
searching for content related to the at least one entity;
determining at least one entity based on the content items found during the search;
generating at least one entity-based widget respective of the contextual content and the entity; and
providing the at least one entity-based widget to a user device.

2. The method of claim 1, wherein the search is performed through at least one of: at least one web source and the user device.

3. The method of claim 1, wherein the request includes a query, wherein the query includes any one of: a keyword and a user's gesture.

4. The method of claim 1, wherein determining the at least one entity further comprising:
determining a search intent of a user providing the query.

5. The method of claim 1, wherein determining the at least one entity further comprising:
tokenizing each content item to at least one token;
processing the tokens by a plurality of classification engines, wherein each engine of the plurality of engines is configured to compute a certainty score that indicates a probability that the at least one token is mapped to at least one entity;
receiving from a set of engines of the plurality of engines their respective entities and computed certainty scores, wherein the set of engines output computed certainty scores above a predefined threshold; and
analyzing the received certainty scores and the respective entities to determine the at least entity.

6. The method of claim 1, wherein each engine of the plurality of engines is further configured to correspond to at least one entity indicating a topic of interest.

7. The method of claim 1, wherein the at least one entity based widget comprises a stand-alone application with limited functionality.

8. The method of claim 1, wherein the least one entity based widget is installed and executed on at least one of: the user device and a webpage accessed by the user device.

9. A non-transitory computer readable medium having stored thereon instructions for causing one or more processing units to execute the method according to claim 1.

10. A system for generating an entity based widget, comprising:
a processing unit; and
a memory connected to the processing unit, the memory containing instructions that when executed by the processing unit, configure the system to:
receive a request to generate at least one entity based widget;
search for content related to the at least one entity;
determine at least one entity based on the content items found during the search;
generate at least one entity-based widget respective of the contextual content and the entity; and
provide the at least one entity-based widget to a user device.

11. The system of claim 10, wherein the search is performed through at least one of: at least one web source and the user device.

12. The system of claim 10, wherein the request includes a query, wherein the query includes any one of: a keyword and a gesture by a user.

13. The system of claim 10, wherein the system is further configured to:
determine a search intent of a user providing the query.

14. The system of claim 10, wherein the system is further configured to:
tokenize each content item to at least one token;
process the tokens by a plurality of classification engines, wherein each engine of the plurality of engines is configured to compute a certainty score that indicates a probability that the at least one token is mapped to at least one entity;
receive from a set of engines of the plurality of engines their respective entities and computed certainty scores, wherein the set of engines output computed certainty scores above a predefined threshold; and analyzing the received certainty scores and the respective entities to determine the at least entity.

15. The system of claim 10, wherein each engine of the plurality of engines is further configured to correspond to at least one entity indicating a topic of interest.

16. The system of claim 10, wherein the at least one entity based widget comprises a stand-alone application with limited functionality.

17. The system of claim 10, wherein the least one entity based widget is installed and executed on at least one of: the user device and a webpage accessed by the user device.
